(19) United States
(12) Patent Application Publication
(10) Pub. No.: US 2009/0132332 A1
(43) Pub. Date: May 21, 2009

(54) COMPUTER IMPLEMENTED SCHEDULING SYSTEMS AND ASSOCIATED METHODS

(75) Inventors: Gregory Belenky, Spokane, WA (US); Hans Van Dongen, Spokane, WA (US)

Correspondence Address: PERKINS COIE LLP;PATENT-SEA, P.O. BOX 1247, SEATTLE, WA, 98111-1247, US

(73) Assignee: WASHINGTON STATE UNIVERSITY, Pullman, WA (US)

(21) Appl. No.: 12/253,703

(22) Filed: Oct. 17, 2008

Related U.S. Application Data
(60) Provisional application No. 60/980,856, filed on Oct. 18, 2007.

(51) Int. Cl. G06Q 10/00

(52) U.S. Cl. 705/9

(57) ABSTRACT

Computer implemented scheduling systems and associated methods are disclosed. In one embodiment, a method for deriving a roster includes generating a roster within the operational constraint by assigning a plurality of workers to a plurality of individual shifts; calculating a value of the operational outcome based on the assigned shifts in the roster; calculating an overall fatigue value for the assigned individual workers based on the assigned shifts in the roster; and determining whether the generated roster is optimized based on the calculated value of the operational outcome and the overall fatigue value of the workers.

### CROSS-REFERENCE TO RELATED APPLICATION(S)

This application claims priority to U.S. Provisional Application No. 60/980,856, filed on Oct. 18, 2007, the disclosure of which is incorporated herein by reference in its entirety.

### BACKGROUND

Fatigue from sleep loss, circadian misalignment, time on task, or other sources degrades cognitive functioning and impairs performance, productivity, and safety. The personal, economic, and social costs involved in errors, incidents, and accidents resulting from fatigue are considerable. Yet, conventional approaches for rostering and work schedule optimization do not take fatigue into account.

### BRIEF DESCRIPTION OF THE DRAWINGS

FIG. 1 is a schematic block diagram illustrating a system for rostering/scheduling based on fatigue in accordance with embodiments of the disclosure.

FIG. 2 is a schematic block diagram illustrating a system for rostering/scheduling based on fatigue in accordance with additional embodiments of the disclosure.

FIG. 3 is a flow diagram illustrating a process for rostering/scheduling based on fatigue in accordance with embodiments of the disclosure.

FIG. 4 is a flow diagram illustrating a search process for rostering/scheduling based on fatigue in accordance with embodiments of the disclosure.

### DETAILED DESCRIPTION

The present disclosure describes systems and methods for rostering and scheduling to reduce fatigue and its consequences by integrating mathematical models capable of predicting fatigue with software/hardware components capable of optimizing rosters and/or work schedules. As a result, rosters/schedules that are conducive to good performance while meeting operational demands for personnel and complying with applicable regulations can be produced. The resulting rosters and/or work schedules can help to sustain performance, productivity, safety, and well-being, while reducing errors, incidents, accidents, and attendant human and economic losses.

### A. INTRODUCTION

Sleep loss and circadian rhythm misalignment degrade alertness and cognitive performance, effectiveness, safety, health, and well-being. Studies of normal human subjects during both acute, total sleep deprivation and chronic, partial sleep restriction consistently reveal robust, replicable cognitive performance decrements. Inefficiencies, errors, accidents, and catastrophes occurring as a consequence of sleep deprivation, sleep restriction, and adverse circadian timing can reduce productivity, add costs, and cause injury and death. In the operational environment, there is often limited time in which to decide and act—putting a premium on accurate, effective, and timely human response. Operational environments include transportation, aviation, maritime operations, medicine, military units, security operations, industrial production, and/or other human activities. When the human fails, the system fails—often with catastrophic consequences. Examples of fatigue-related catastrophes primarily involving human failure due to sleep loss and adverse circadian timing are Three Mile Island, the Challenger launch decision, Chernobyl, and the Exxon Valdez.

In the U.S. Army, sleep is viewed as an item of logistic re-supply (similar to ammunition, fuel, food, water, and other critical consumables). Effective management of any critical item of logistic re-supply requires that the commander (in the military context) or manager (in the civilian context) knows how much of the item is on hand and knows what the anticipated rates of use are. With accurate knowledge of these quantities and a model relating one to the other, the commander or manager can then plan/schedule for adequate re-supply. Thus, in the vision of the military, sleep can be optimized as part of the overall logistics of re-supply and operational scheduling. Similarly, several embodiments of the disclosure can be used to optimize the overall logistics and operational scheduling of an organization, military or civilian, including the timing and duration of periods for sleep, so as to minimize fatigue and maximize operational efficiency within the framework of operational constraints and other optimization of objectives.

Fatigue can be operationally defined as a deterioration in performance capability, and can be a function of sleep/wake history (time awake), circadian rhythm (time of day), sleep inertia (transient sleepiness immediately after awakening), workload (time on task, duty hours, nature of work), and/or other suitable factors. The experimentally determined effects of sleep/wake history and circadian rhythm on sleep propensity, alertness, and performance may be used to develop mathematical models for predicting performance based on these factors. Suitable mathematical models can include two-process models that invoke the homeostatic drive for sleep and the circadian rhythm in sleep propensity as processes driving sleepiness and fatigue. Other mathematical models can also use shift timing and duration (constituting a rough estimate of workload), as well as time of day (constituting a rough estimate of circadian rhythm phase) as their inputs.

With a validated model predicting fatigue and performance on the basis of some combination of shift timing and duration, sleep/wake history, and circadian rhythm phase, it is believed that the effects of any possible schedule can be evaluated without having to test that schedule experimentally. A model can be validated on specific data sets, and is then assumed to generalize to predict the performance consequences of any possible schedule, thus obviating the need for specific experimental scrutiny of each specific schedule. The predictions of a fatigue model can be adjustable to predict objectively measurable loss in productivity (e.g., in transportation—increased fuel consumption and increased maintenance) and other operationally relevant performance outcomes.

### B. EMBODIMENTS OF ROSTERING AND SCHEDULING SYSTEMS AND METHODS

Several embodiments of the disclosure are configured to use the tools of applied mathematics (e.g., mathematical modeling) based on knowledge from engineering, management, mathematics, and psychology to analyze and manipulate complex operational systems. In several embodiments, operational aspects of industrial operation can be encapsulated into a quantitative model: an objective function; and then the function can be manipulated to at least increase or maximize desirable operational outcomes (e.g., profit, assembly line output, crop yield, bandwidth, etc.) and/or to at least decrease or minimize undesirable operational outcomes (e.g., fatigue, loss, risk of error, accidents, cost of operations, etc.) while staying within the bounds of operational constraints. The phrase “operational constraint” generally refers to limitations and/or restrictions that a particular process or operation must follow or that would be desirable to meet. Such limitations or restrictions may be legal, physical, functional, economical, and/or of other types.

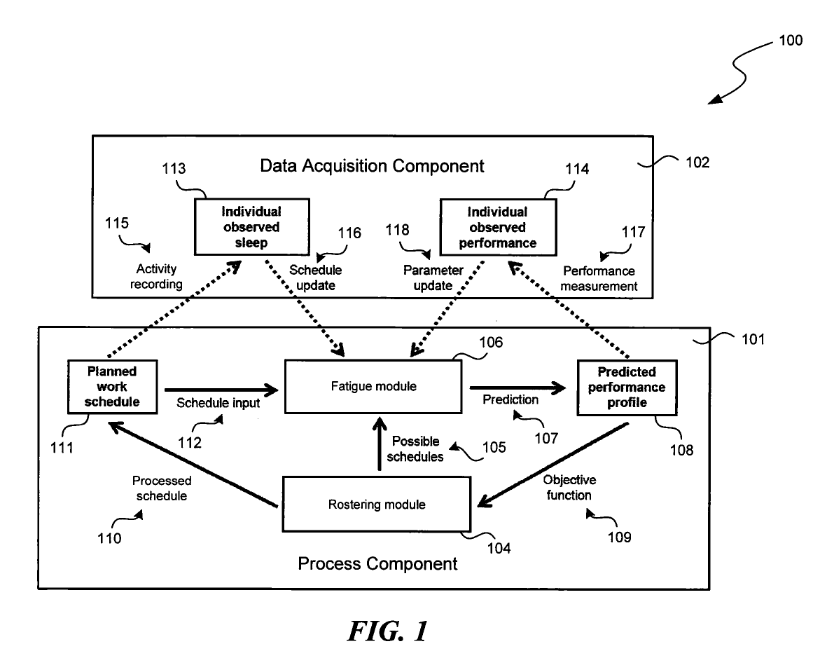

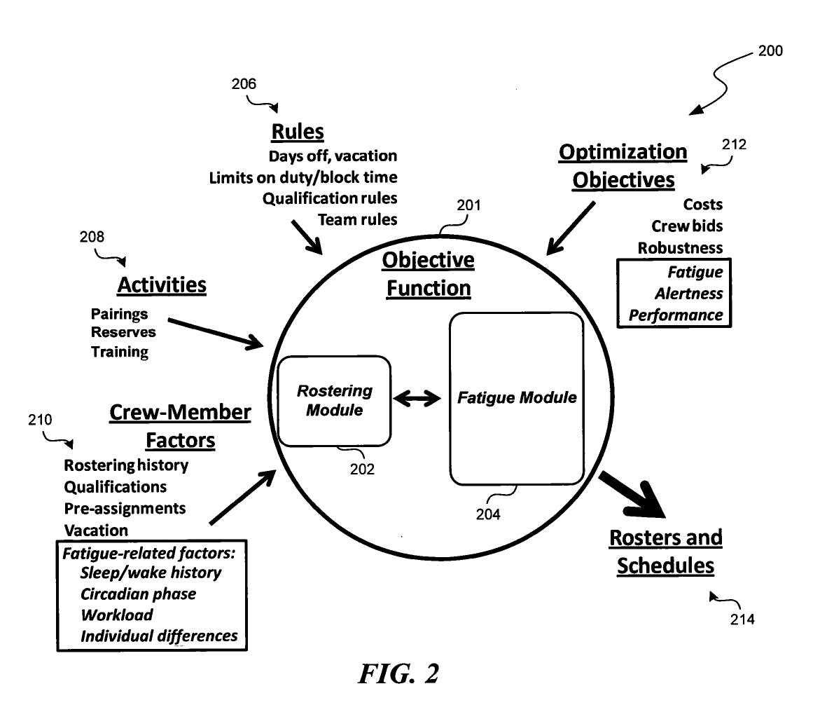

FIG. 1 and FIG. 2 are schematic block diagrams illustrating rostering/scheduling systems in accordance with embodiments of the disclosure. In these Figures, each component may be a computer program, procedure, or process written as source code in a computer programming language, such as PASCAL, C++, and/or other suitable programming language, and may be presented for execution by a processor of a personal computer, a network server, a laptop computer, and/or other suitable computing devices. Each component may also be implemented as an application specific integrated circuit, an optical circuit, and/or other suitable hardware devices. The various implementations of the source code and object byte codes may be stored on volatile and/or nonvolatile media (e.g., ROM; RAM, magnetic disk storage media; optical storage media; flash memory devices, and/or other suitable storage media), and/or other suitable computer-readable storage media. As shown in FIG. 1, the system 100 may include a process component 101 operatively coupled to an optional data acquisition component 102.

As shown in FIG. 1, the process component 101 can include two basic software modules: a rostering module 104 and a fatigue module 106 operatively coupled to each other. In the described embodiment, both of these modules can be executed on a single computer device. However, in other embodiments, these modules can also be executed in a distributed computing environment.

The rostering module 104 can be configured to generate possible schedules 105 based on tasks to be completed, resources available, applicable rules and regulations, and/or other operational information. The techniques of operational research can be applied to develop routines for the rostering module 104 (e.g., for commercial aviation and other modes of transportation). Such techniques use mathematical models to capture real-world problems of crew rostering, including both operational constraints and objectives against which to optimize. One aspect in developing such a system is to encapsulate in a mathematical model, i.e., an objective function 109, industrial knowledge, for example, the structure, operations, and outcomes of a particular operation (e.g., transportation, production, and/or other types of operations). Any desired constraints or objectives that can be encapsulated in a mathematical model can be incorporated into the objective function 109.

The fatigue module 106 receives the possible schedules 105 and generates a fatigue prediction 107 based on the possible schedules 105. Several embodiments of the fatigue module 106 can include computation routines based on mathematical models (e.g., the two-process model) describing fatigue-related degradation in alertness, performance, and productivity encapsulating detailed knowledge of the effects of sleep/wake history, circadian amplitude and phase, sleep inertia, workload (time on task, duty hours, nature of work), individual differences on these parameters, and/or other suitable factors.

The generated fatigue prediction 107 can then form a predicted performance profile 108. The rostering module 104 can then utilize the objective function 109 to evaluate the predicted performance profile 108 and generate a processed schedule 110 in which desired operational outcomes and/or a desired level of fatigue on the crew members are simultaneously optimized within the operational constraints. The processed schedule 110 can then form a planned work schedule 111. In certain embodiments, the planned work schedule 111 can be provided to the fatigue module 106 as a schedule input 112 for generating a new fatigue prediction 107, and be processed based on the foregoing procedures until a desired work schedule (e.g., with the lowest fatigue score) is obtained that meets the relevant operational constraints.

The data acquisition component 102 can include an individual observed sleep module 113 and an individual observed performance module 114. The individual observed sleep module 113 can record an individual crew member's activity 115 including sleep and awake using a log, an online recording tool, and/or other suitable techniques. The individual observed sleep module 113 can then update the planned work schedule 111 as a schedule update 116 based on the activity recording 115 and provide the schedule 111 to the fatigue module 106 to update parameters for modeling the crew member's fatigue.

Similarly, the individual observed performance module 114 can obtain a performance measurement 117 for the crew member based on the predicted performance profile 108 using indices of productivity, alertness, etc. The individual observed performance module 114 can then provide the performance measurement 117 to the fatigue module 106 to update the parameters for modeling the crew member's performance.

As shown in FIG. 2, the system 200 can include an objective function 201 that includes at least a rostering module 202 and a fatigue module 204 operatively coupled to each other. In accordance with an aspect of the disclosure, the objective function 201 can include a mathematical representation of the scheduling and/or other operational constraints of an operational setting, the relative advantage of particular scheduling schemes, the cost associated with schedules examined relative to resources available, and the advantages of schedules examined relative to productivity and other real or perceived benefits, and cost of fatigue and concomitant performance impairment.

The objective function 201 can be minimized (or maximized) using mathematical and/or numerical approaches typically performed with the use of a computer to determine the schedule that is most suitable relative to the weighted elements of the objective function. For example, the objective function 201 can be minimized (or maximized) based on a weighted average of cost, risk, fatigue level of the crew members, and/or other suitable operational outcomes.

The objective function 201 can include a plurality of input parameters. For example, as shown in FIG. 2, the input parameters can include rules 206 (e.g., days off, vacation, limits on duty/block time, qualification rules, team rules, etc.), activities 208 (e.g., pairings of crew members, reserves, training, etc.), crew-member factors 210 (e.g., rostering history, qualifications, wages/salaries, pre-assignments, vacation, sleep/wake history, circadian phase, workload, individual differences, etc.), and optimization objectives 212 (e.g., costs, crew bids, robustness of schedule, fatigue, alertness, performance, etc.). In other examples, the objective function 201 can also include sleep inertia, workload (time on task, duty hours, nature of work), individual differences, and/or other suitable input parameters.

Several embodiments of the foregoing systems and methods can be used to address a broad range of fatigue related process optimization issues, e.g., maximizing cargo flows through port facilities, optimizing factory floor layouts and materiel flows, managing cost versus quality in telecommunications networks, and optimizing road traffic patterns and flows. Specifically in the area of scheduling, several embodiments of the disclosure may include Fostering and scheduling of personnel in commercial aviation, in durable equipment manufacture, in a sequence of tasks in a project, and in managing network traffic including air traffic control.

In accordance with aspects of several embodiments of the disclosure, the techniques described herein can improve the industrial knowledge-based objective functions by incorporating at least one mathematical model predicting fatigue based on, e.g., shift-timing and duration, estimates or actual measurements of sleep obtained, sleep/wake history, circadian rhythm phase and amplitude, sleep inertia, workload, individual differences in response to these factors, and/or other suitable factors. As a result, several embodiments of the disclosure can enable effective turn-key, automated, operation-wide fatigue risk management.

Several embodiments of the disclosure can also enable fatigue risk management. Fatigue risk management in one form proposes a multi-layered defense-in-depth against fatigue-related degradation in performance and productivity and fatigue-related errors, incidents and accidents guided by, e.g., the “Swiss cheese” model of accident causation. In one example, the fatigue risk management includes three layers of defense: a first layer inquires whether the timing and duration of on-duty periods allow adequate opportunity for sleep both in terms of duration and timing; a second layer inquires whether the employee in question takes advantage of the opportunity for sleep and whether adequate sleep is in fact obtained; and a third layer inquires, given the opportunity for sleep and the use made of the opportunity, whether the employee in question performs well while on duty. Several embodiments of the system described in the disclosure can optimize the timing and duration of sleep opportunity and/or advantageously deploy fatigue countermeasures when timing and duration of sleep are constrained to be less than optimal, thus improving performance under operational constraints and contributing to fatigue risk management.

A feature of several embodiments of the disclosure is that sleep/wake/work schedules can be manipulated to reduce fatigue within existing operational constraints. Another feature is that the systems and methods may not require or use actual measurements or observations of fatigue or performance in the workplace (although such measurements could be used as additional information to be integrated with the objective function). A further feature is that the systems and methods can account for transient or adventitious variations in cognitive performance from sources as a result of how the individual sources affect the sleep/wake history (e.g., age) and/or physiological time of day (e.g., shift work). Such sources may not have to be treated as having effects on cognitive performance independent of the sleep/wake/work history and/or the time of day, and as such do not require separate measurement, tabulation, and input.

The following example illustrates one implementation of the systems and methods discussed above. Even though the example was constructed with a specific programming language and/or heuristics, in other embodiments, the systems and methods can also include other suitable heuristics for performing the illustrated functions.

### C. EXAMPLES

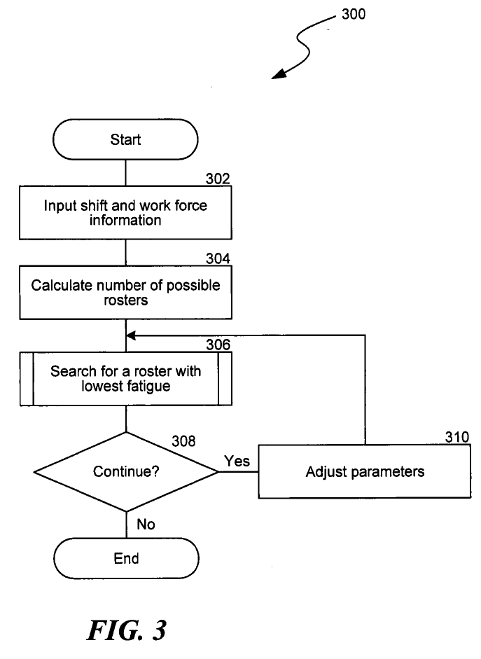

FIG. 3 is a flow diagram illustrating a process 300 for rostering/scheduling based on fatigue in accordance with embodiments of the disclosure. In the illustrated embodiment, the process 300 can be embodied in a piece of software written in TURBO PASCAL and executable on an IBM-compatible personal computer under the DOS operating system or an equivalent computer setup. In other embodiments, the process 300 can also be embodied as a piece of software written in C, C++, and/or other suitable programming language and executable on Unix-based, Linux-based, and/or other suitable types of computing devices.

The process 300 can manipulate and optimize the assignment of a work force to a shift schedule. In the illustrated embodiment, the optimization is based on coverage of all shifts with minimal overall estimated fatigue when assigning individuals to cover work shifts in the face of operational constraints. The process 300 can provide a preferred solution or, if the preferred solution is not unique, one of the preferred solutions. The examples of operational constraint addressed by the example are as follows:
1) All work shifts must be covered;
2) No individual can work more than one shift at a time;
3) No sleep is allowed during work shifts; and
4) The roster should use the available work force as efficiently as possible, by
   a. Using as few individuals as possible to cover the shifts; or
   b. Distributing the work by giving all available individuals at least one shift.

At an initial stage, the process 300 includes inputting shift and work force information (block 302). In the example, the particular process 300 is configured to read two input files, indicated by name as command line parameters when the process 300 is executed in the DOS operating system.

The first input file contains the shift schedule, in this case in the form of start and stop times of each shift expressed in cumulative clock time (where, e.g., 23 stands for 11 pm, 24 stands for 12 am the next day, 25 stands for 1 am the next day, and so on). An example involving seven work shifts in a 36-hour period is illustrated, that is, the first input file contains the following 7 shifts (in hours of cumulative clock time):

Shift 1: 8-17 hours cumulative clock time

Shift 2: 16-23 hours cumulative clock time

Shift 3: 22-31 hours cumulative clock time

Shift 4: 30-36 hours cumulative clock time

Shift 5: 32-40 hours cumulative clock time

Shift 6: 9-14 hours cumulative clock time

Shift 7: 36-44 hours cumulative clock time

The example first input file corresponding to the foregoing shift schedule contains:

8 17

16 23

22 31

30 36

32 40

9 14

36 44

The above shifts are illustrated graphically below (cumulative hours 8 through 27—1^{st} four rows; cumulative hours 28 through 44—2^{nd} four rows):

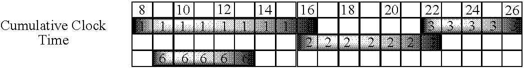

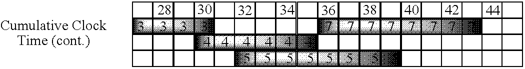

The number in the top rows of each of the four-row blocks indicates cumulative clock time in hours. The second four-row block is continued from the first. The three rows below the top rows in each four-row block indicate the seven shifts (shown in grey), numbered from 1 to 7 from their order in the first input file. The vertical lines mark the passing hours. Note that the various shifts are partially overlapping making it a non-trivial problem to assign individuals to these shifts.

The second input file contains information about the available work force. In this example, the file contains the names of available individuals, and a measure of their morning/evening preference/type. The latter is believed to be associated with a difference in the timing of the circadian rhythm, behaviorally varying from about 2 hours earlier for extreme morning types to about 2 hours later for extreme evening types as compared to average intermediate types.

An example of the second input file containing 4 individuals is as follows:

0 John

−1 Anita

2 Carl

−2 Marc

where the number preceding each name indicates that person's morning/evening preference (e.g., as obtained by morning/evening preference questionnaire), with positive numbers indicating evening type and negative numbers indicating morning type. Thus, in the example above, John is designated as an intermediate (neither morning nor evening) type; Anita is a moderate morning type; Carl is an extreme evening type; and Marc is an extreme morning type.

After reading the two input files, the process 300 can include calculating a number of possible rosters based on the input shift and work force information (block 304). In this example, the number of possible rosters can be calculated as the number of permutations for assigning each worker to each shift. Thus, in this example, the number of possible rosters is 4⁷ (i.e., 4 individuals to the power of 7 shifts), which equals 16,384.

The process 300 can optionally receive or determine what additional penalty can be added to the objective function for the size of the work force. This penalty may serve to change the balance in the optimization process so as to favor either minimizing the size of the work force used, or to maximize the distribution of the shifts over as many individuals as possible. The penalty can take the form of a percentage fatigue level one is prepared to allow in exchange for adding (or subtracting) an individual to the work force schedule. Thus, if the optimal solution with no penalty involves scheduling only 3 out of 4 individuals to cover the 7 shifts, then adding a negative penalty for work force may tip the balance to including all 4 individuals in the rostering, while adding a positive penalty may tip the balance to covering the 7 shifts with only 2 individuals at the cost of additional average fatigue. However, if the additional average fatigue thus incurred would be too high, then the objective function would not be minimized with the reduced or increased work force despite the penalty, and a solution with 3 individuals might still be optimal. In one example, 0 is entered as the work force penalty. In this specific case, a tiny penalty for work force is still imposed automatically, namely 0.01% on the fatigue scale. This serves to favor a solution with fewer individuals over a solution with more individuals if the overall estimated fatigue level is the same. This meets criterion 4a) above.

Even though the objective function employed in the process 300 is calculated in terms of percentage of the fatigue level, the objective function may be adjusted to disfavor solutions that are non-optimal for reasons other than the level of fatigue. For example, a very large value (e.g., 10,000,000%) may be added to the objective function for rostering solutions that would involve one individual working more than one shift at a time, as this would violate criterion 2) above and thus would never constitute an optimal solution (and would not be selected as such as it would not yield a minimal value of the objective function).

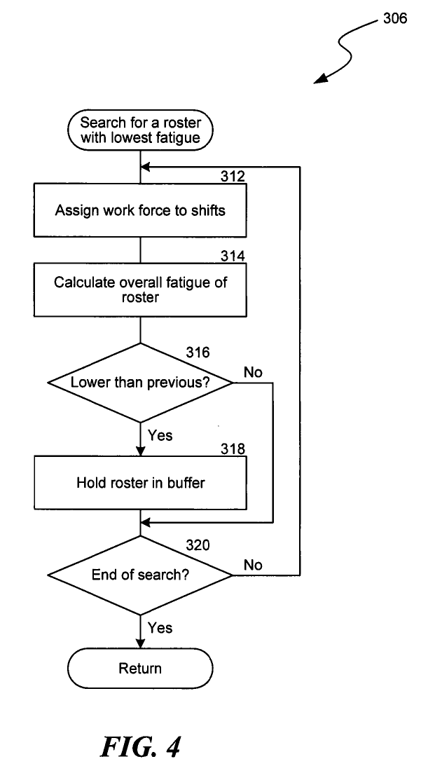

The process 300 can then include searching for at least one roster with the lowest overall fatigue level (block 306), as described in more detail below with reference to FIG. 4. The process 300 can then include a decision block 308 to determine whether the process will continue. In one embodiment, the process 300 can be continued when an operator adjusts parameters (block 310) for the objective function, and the process reverts to searching for at least one roster with the lowest overall fatigue level at block 306. Otherwise, the process ends.

FIG. 4 is a flow diagram illustrating a search process 306 for rostering/scheduling based on fatigue in accordance with embodiments of the disclosure. In the illustrated embodiment, the process 306 includes conducting an exhaustive search across all possibilities of assigning each of the work shifts to each of the available individuals of the work force to cover all shifts for meeting criterion 1) above. For example, the search process 306 can include assigning at least some of the individuals in the work force to the shifts to obtain a roster (block 312) and calculating an overall fatigue level of the assigned roster (block 314).

In the illustrated embodiment, calculating the overall fatigue level of the assigned roster can include calculating the fatigue levels (including estimating the scheduled individuals' sleep times) across the 36 hours of the work schedule for each of the four individuals in the work force. In the illustrated embodiment, fatigue is estimated using the two-process model that predicts the level of homeostatic pressure for sleep and the state of the circadian rhythm over time. The model estimates when sleep is likely to occur, which is when the homeostatic pressure for sleep exceeds an upper threshold modulated by the circadian rhythm; and when sleep is likely to terminate, which is when the homeostatic pressure for sleep drops below a lower threshold modulated by the circadian rhythm.

The model also estimates the level of fatigue during wakefulness, which can be represented by the calculated difference between the homeostatic pressure and the circadian rhythm. As such, the model can predict the level of fatigue by tracking the homeostatic and circadian processes over time across estimated/projected periods of wakefulness, including forced wakefulness due to assignment to a work shift and estimated/projected periods of sleep. In the particular implementation, the level of fatigue is expressed as a percentage score, with 100% indicating extreme fatigue and 0% indicating negligible fatigue. In other implementations, the level of fatigue can also be expressed as a deviation from a normal value, an integer score, and/or other suitable metric.

In the particular implementation, the calculation of fatigue levels in each individual occurs as follows. First, initial states are determined for the individual at hand. In the particular implementation, it is assumed that the individual is fully rested and in a steady state, i.e., sleep is taken such that there is a balance between the homeostatic and circadian processes. For an intermediate type individual, the two-process model predicts that this occurs when a person sleeps 8 hours per day between 11:30 pm and 7:30 am; these times are adjusted for individuals with different degrees of morning/evening preference/type. Steady state is assessed by modeling 10 days with sleep, which is believed to allow sufficient time for the two-process model to reach its steady state, using the published parameter values of the two-process model with adjustment to the timing of the circadian rhythm for morning/evening as per the content of the second input file. The predictions for estimated homeostatic pressure and for estimated sleep times over the last 24 hours of the modeled 10 days are stored in a database so that the individual-specific initial values can be retrieved that correspond to the beginning of the work schedule specified in the first input file. The initial value for the circadian rhythm can be calculated directly or as a value stored in the database. The initial states may be calculated once for every possible roster considered.

Starting from the person-specific initial states, the search process 306 then tracks the homeostatic process and the circadian process of the two-process model for each individual in the roster across the duration of the work schedule defined in the first input file. This may be done in steps of 0.5 hours, but the equations of the two-process model are invariant to the choice of the time step, and smaller (or larger) time steps may also be used. During periods of wakefulness, the homeostatic pressure for sleep is increased in a saturating exponential manner asymptoting at 1, while during sleep the homeostatic pressure is decreased in a saturating exponential manner asymptoting at 0. The circadian rhythm is calculated by evaluation of the closed form harmonic equation of the two-process model.

When the homeostatic pressure for sleep increases above an upper threshold (calculated by adding an offset to the circadian rhythm), then sleep is assumed to occur. When the homeostatic pressure for sleep decreases below a lower threshold calculated by adding a smaller offset to the circadian rhythm, then sleep is assumed to terminate spontaneously. However, during scheduled work shifts no sleep is assumed to occur—this meets criterion 3) above. Fatigue is calculated as the difference between the homeostatic pressure for sleep and the value of the circadian rhythm, and expressed as a percentage. Across the scheduled work hours, fatigue is recorded in computer memory. The total level of fatigue occurring during all scheduled work shifts for the individual at hand (in steps of 0.5 hours or any other chosen time step) is added to the objective function. After all individuals have thus been modeled, the final value of the objective function is stored in a computer memory. Relevant penalties may be added as described herein.

The search process 306 can then include a decision block 316 to determine whether the fatigue level of the current roster is lower than that of a previous roster. If yes, the current roster and the corresponding fatigue level are held in a buffer (block 318); otherwise, the search process continues to another decision block 320 to determine if the search process 306 should continue. In one embodiment, the search process 306 is continued if there are still other possible rosters remaining, i.e., a loop counter has not reached the number of possible rosters. In other embodiments, other parameters and/or conditions can be used to terminate the search process 306. If all possible rosters have been searched or the process is otherwise terminated, the process returns.

As described above, over all the possible rosters, the roster that has the lowest value for the objective function (or the first or last one encountered if there are multiple rosters with identical objective functions) is selected as the optimal roster. This manipulation of the objective function is believed to identify a roster that generates minimal estimated fatigue across all work schedules for all individuals, while meeting the operational criteria 1) through 4) above.

The particular implementation of the process 300 can optionally include printing on a display (e.g., a computer screen) what are the value of the objective function and the corresponding shift assignments. It can also show how many of the available individuals were used to staff the work shifts, and what the average fatigue level per unit time was as estimated by the fatigue model. In the example with 7 shifts and 4 individuals, the output can be as follows:

Value of minimized objective function: 33.9

Shift assignments of optimal roster:
Shift 1 goes to John.
Shift 2 goes to Carl.
Shift 3 goes to Marc.
Shift 4 goes to Anita.
Shift 5 goes to John.
Shift 6 goes to Anita.
Shift 7 goes to Carl.
Number of individuals used: 4 out of 4.
Average fatigue level (0%-100% scale): 32.6%.
   Illustrated graphically, this represents the following optimal roster:

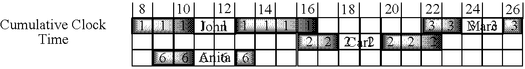

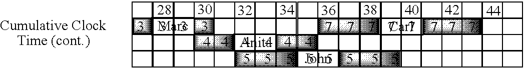

Here the top numbers indicate cumulative clock time in hours. The three rows below indicate the 7 shifts shown in grey, and the text indicates to whom these shifts are assigned. The vertical lines mark the passing hours.

The process 300 can also include generating an output file which contains the fatigue model predictions (e.g., homeostatic pressure, circadian rhythm, estimated sleep/wake state, and fatigue level by time point), for each of the individuals, across the duration of the work schedule, for the optimal rostering solution. If there is no optimal solution (e.g., if one were to attempt to fill all the shifts with only one individual), then the software reports such a finding.

Conventional rostering procedures and/or a human expert knowledgeable about fatigue would not likely arrive at the same conclusion as shown above, even if their roster of choice was picked from a set of candidate rosters after having been compared in terms of fatigue by means of a post-hoc application of a fatigue prediction model. It is believed that for the optimal roster to emerge among the many possibilities in the first place, fatigue may be incorporated in the objective function during the optimization process as shown in FIG. 2, not afterwards. Thus, conventional rostering would have likely resulted in a roster involving greater estimated fatigue, potentially decreasing productivity and increasing safety risks.

To illustrate the impact of operational constraints, the previous example was repeated once more with a work force penalty imposed such that a 5% increase in average fatigue for each individual is tolerated. The sample output is as follows:

Value of minimized objective function: 50.6

Shift assignments of optimal roster:
Shift 1 goes to Anita.
Shift 2 goes to John.
Shift 3 goes to Carl.
Shift 4 goes to Anita.
Shift 5 goes to John.
Shift 6 goes to John.
Shift 7 goes to Carl.
Number of individuals used: 3 out of 4.
Average fatigue level (0%-100% scale): 33.7%.

This solution differs from the previous roster in that the shifts can be covered with only 3 individuals while average fatigue is only 1.1% greater. Also, John is asked to work two shifts that are almost back to back (shift 6 from 9 until 14 hours, and shift 2 from 16 until 23 hours). This seemingly counterintuitive schedule is nevertheless the optimal solution of the rostering problem that minimizes fatigue given the new operational constraints as represented by the objective function. This roster would likely be overlooked when using conventional rostering and scheduling approaches, as the inclination would be to assign shifts 2 and 6 to two different individuals.

Conventional rostering procedures typically do not distinguish individuals in terms of their fatigue-related characteristics. For example, from the perspective of scheduling, the above roster with the individuals interchanged (e.g., Anita taking Carl's shifts and Carl taking Anita's shifts) would seem equally effective. However, when morning/evening preferences and their effects on sleep and fatigue are accounted for, the roster with some of the individuals interchanged would no longer be equally effective, and only the specific roster shown above is optimal. On that basis alone, the invention allows a user to pick the optimal schedule among what would otherwise seem to be a large number of equivalent rosters, and thus it limits the choices by up to a factor equal to the factorial of the number of individuals (in this case 4!=1×2×3×4=24; for a case with 10 individuals there would be 10!=3,628,800 possibilities to choose from). To illustrate, the process was performed assuming that all individuals have intermediate circadian preference as shown in the following example of the second input file:

0 John

0 Anita

0 Carl

0 Marc

The output of the process shows the following solution, which is again different from the previous example:

Value of minimized objective function: 37.3

Shift assignments of optimal roster:
Shift 1 goes to Carl.
Shift 2 goes to Anita.
Shift 3 goes to John.
Shift 4 goes to Anita.
Shift 5 goes to Carl.
Shift 6 goes to Anita.
Shift 7 goes to John.
Number of individuals used: 3 out of 4.
Average fatigue level (0%-100% scale): 35.9%.

In addition to optimizing rosters and schedules, certain embodiments of the disclosure can be used to optimize timely deployment of fatigue countermeasures, including but not limited to, on the job napping and on duty caffeine consumption. Moreover, the optimization process can be made to take into account the availability of fatigue countermeasure resources (e.g., in situations when supplies such as caffeine may be limited, as, for example, during military operations or in remote locations).

In addition to optimizing rosters for minimal average fatigue, the objective function can also be formulated such that the optimization process aims to minimize the duration of periods of extreme fatigue, minimizes peak fatigue levels, maximizes periods of low fatigue, or any variation of what could be considered optimal with regard to fatigue. Furthermore, in addition to or in lieu of the fatigue model, several embodiments of the process 300 can include a model that predicts sleepiness, alertness, cognitive performance, efficiency, productivity, safety, risk, errors, incidents, accidents, or costs associated with fatigue. For example, a plurality of risk levels can be assigned to various fatigue levels based on preselected fatigue thresholds, with or without adjustments for the nature of the tasks at hand, and the objective function can be formulated such that its minimization (or maximization) leads to a roster with the lowest risk level given other operational constraints and optimization objectives. Even though the process 300 is described above for minimizing fatigue for a given crew size, several embodiments of the disclosure can be used to determine optimal crew size for a given level of fatigue.

Optimizing fatigue in the context of operational constraints can also be construed more broadly as part of the overall logistical optimization scheme of an operation, such as combat operations, energy production, natural resource extraction (e.g., oil wells and mines), and transportation (e.g., aviation). Those skilled in the art will recognize that incorporating fatigue modeling into the logistical optimization scheme uses the same principles as incorporating fatigue modeling into scheduling and rostering, and will realize that the invention may be expanded to the level of logistical optimization.

### D. ADDITIONAL EMBODIMENTS

Even though the technique is described above for optimizing schedules based on fatigue, in certain embodiments, the scheduling and rostering optimization can also be based on operational risk in addition to or in lieu of fatigue. Operational risk can include safety and productivity, and a variety of other loss or liability issues, which may be determined by fatigue in addition to other factors, such as density of exposure (e.g., exposure to traffic as a risk factor for accidents in transportation settings); operational criticality of specific personnel; and critical phases of operations, including, but not limited to, pilots during takeoff and landing, astronauts during docking maneuvers, and ship captains and pilots while maneuvering in restricted waterways and ports. These operational risk factors may be included as part of the objective function.

Even though the technique is described above for optimizing the assignment of individuals to given work schedules, several embodiments of the rostering optimization process can also include examining different work schedules (e.g., different beginning and end times for scheduled shifts) to further improve the roster in terms of fatigue levels and/or other operational constraints. Such improvement can be accomplished, for example, by representing in the objective function a measurement of flexibility in the scheduled shifts, or by broadening the number of possible schedules examined by including variants allowable based on the flexibility of the scheduled shifts.

In addition to defining fatigue as a predicted percentage score, several embodiments of the disclosure can be implemented using other metrics for the prediction of fatigue, e.g., scores on sleepiness/fatigue questionnaires and scales; sleep latency on a multiple sleep latency test or similar test of fatigue; performance on a psychomotor vigilance test or other cognitive performance task, and/or other operational or theoretical definitions of fatigue.

In addition to or in lieu of individual characteristics of morning/evening preference, many other characteristics of the individual or groups of individuals can also be used in the optimization process. For example, in addition to the factors shown in FIG. 2, individual vulnerability to sleep loss, other phenotypes, genotypes, restrictions on which shifts individuals can and cannot work (e.g., because of qualifications), preferred staff pairings, etc., may also be used. Group distributions of such characteristics may also be used to describe large work forces, and may be applied in the optimization process by means of Bayesian statistics, Monte Carlo based sampling strategies, and/or other suitable techniques.

In the foregoing description, time is tracked as cumulative clock time. Those skilled in the art will recognize that in other embodiments, time can be represented in a range of other formats, e.g., seconds or (fractional) days and time measured in terms of universal time or any other time scale.

Further, the exhaustive search used in the foregoing example is just one of many routines that can be used to perform the process, including procedures based on or incorporating analytical solutions, differentiation, matrix algebra, linear and nonlinear programming, genetic algorithms, Monte Carlo based sampling strategies, bootstrapping, Bayesian statistics, etc.

In further embodiments, the objective function can be maximized rather than minimized without loss of generalizability. Those skilled in the art will recognize that the objective function cast in terms of fatigue scores is just one of many objective functions that can be used to accomplish the same or similar effects. The objective function can be expressed in a variety of metrics (one-dimensional or even multi-dimensional), so long as minimization (or maximization) of the objective function leads to finding the optimal solution of the problem addressed. Likewise, penalties and adjustments applied to the objective function can take a variety of forms, metrics, and magnitudes. Rosters that cannot meet basic operational criteria (e.g., one individual having to work multiple shifts at the same time) can be ruled out by means of a large penalty to the objective function, or they can be removed from consideration in the optimization process beforehand with equal effectiveness.

In addition, the two-process model is just one of many possible ways to estimate fatigue. Other methods can include 1) alternative fatigue and performance models; 2) direct measurement of fatigue; and 3) a combination of direct measurement of fatigue and mathematical modeling.

Moreover, estimating sleep time from the two-process model is just one of many possible ways to estimate sleep time. Other methods can include 1) direct measurement from polysomnographic recording, actigraphy, and self-reporting; 2) indirect estimation from shift timing and duration; 3) alternative sleep estimation models. Further improvements of the accuracy of fatigue estimation may be achieved by including more detailed models of sleep and its architecture. However, the disclosed systems and methods are not contingent upon inclusion of estimation of sleep time; other means of estimating recuperation from work may be utilized including but not limited to 1) attributing a nominal or time-proportional recuperative value to each period off work; and 2) estimating recuperation on the basis of rest breaks instead of sleep.

Various embodiments of the disclosed systems and methods can be implemented as 1) a stand-alone utility loaded and executed as software in a computer, 2) hard-wired in a fixed location or as part of a portable device, or 3) a module as part of a larger data management or logistical management system or software tool.

Several embodiments of the systems and methods can be applied to any activity or operation that is staffed with extended work hours, shift work, and/or 24×7 operations. Such activities or operations include, e.g., commercial aviation, trucking, maritime operations, military operations, space flight, health care, emergency response, manufacturing, global financial markets, resource extraction (mining, drilling), and energy production. Several embodiments of the systems and methods can optimize rostering and scheduling for personnel against operational constraints to at least reduce fatigue and attendant fatigue-related errors, incidents, or accidents.

From the foregoing, it will be appreciated that specific embodiments of the disclosure have been described herein for purposes of illustration, but that various modifications may be made without deviating from the disclosure. For example, initial values for fatigue estimation across a schedule can be derived from calculation over given sleep/wake history or assumption of a statistical distribution and/or other suitable computation and/or measurements. In another example, several embodiments of the foregoing systems and methods can also be implemented to produce fatigue-friendly schedules that are frequently updated through real-time (or off-line) re-optimization based on new information being received about the operational environment or the individuals in a roster. Certain aspects of the disclosure described in the context of particular embodiments may be combined or eliminated in other embodiments. Not all embodiments need necessarily exhibit such advantages to fall within the scope of the disclosure. Accordingly, the invention is not limited by the disclosure, but instead its scope is to be determined entirely by the following claims.

I/We claim:

1. A computer implemented method for generating a roster for an operation, comprising:
inputting information of a plurality of shifts of the operation and resource units to an objective function, the objective function encapsulating at least one operational constraint of the operation, wherein the objective function incorporates a fatigue module configured to calculate a fatigue level for the individual resource units;
evaluating the objective function to
generate a plurality of possible rosters within the operational constraint for assigning the resource units to the individual shifts;
calculate an overall fatigue metric for the individual rosters based on the individual fatigue levels for the individual resource units and the assigned shifts; and
select a roster from the plurality of generated rosters, the selected roster being optimized for the overall fatigue metric.

2. The method of claim 1 wherein evaluating the objective function includes evaluating the objective function to select a roster from the plurality of generated rosters, the selected roster being optimized for the overall fatigue metric including at least one of an overall fatigue level, a variability in a fatigue level, a duration of excessive fatigue, and a peak fatigue level.

3. The method of claim 1 wherein the objective function further encapsulates at least one operational outcome, and wherein evaluating the objective function includes evaluating the objective function to select a roster from the plurality of generated rosters, the selected roster being simultaneously optimized for the operational outcome and the overall fatigue metric.

4. The method of claim 1 wherein the objective function further encapsulates at least one operational outcome, and wherein
inputting information includes
inputting a first data set containing a plurality of shifts individually containing a start time and a stop time; and
inputting a second data set containing a plurality of workers with corresponding morning/evening preferences;
and wherein evaluating the objective function includes:
generating a first roster by assigning the individual shifts to at least some of the individual resource units;
tracking a homeostatic pressure and a circadian rhythm for the individual resource units based on the assigned shifts;
calculating a value of the operational outcome for the first roster based on the assigned shifts;
calculating the fatigue level for the individual resource units as a difference between the homeostatic pressure and a value of the circadian rhythm for the individual resource units;
summing the fatigue levels of the individual resource units to derive a first overall fatigue level;
calculating a first overall score of the first roster as a weighted mean of the value of the operational outcome and the first overall fatigue level;
comparing the first overall score to a second overall score associated with a second roster, the second overall score and the second roster being stored in a buffer;
if the first overall score is lower than the second overall score, overwriting the second overall score and the second roster with the first overall score and first roster, respectively, in the buffer; and
else, maintaining the second overall score and the second roster in the buffer; and
wherein the method further includes repeating evaluating the objective function until at least some of the possible rosters have been processed.

5. The method of claim 1 wherein inputting information includes inputting a first data set containing a plurality of shifts and a second data set containing a plurality of workers with corresponding morning/evening preferences.

6. The method of claim 1 wherein evaluating the objective function includes calculating a number of permutations for assigning at least some of the resource units to the plurality of shifts.

7. The method of claim 1 wherein evaluating the objective function includes calculating a number of possible rosters (N) for assigning at least some of the resource units to the shifts as follows:
N=R^{S}
where R is a number of the resource units and S is a number of the shifts.

8. The method of claim 1 wherein evaluating the objective function includes:
generating a roster by assigning at least some of the resource units to the individual shifts;
calculating a fatigue level for the individual resource units based on the assigned shifts; and
summing the fatigue levels for the individual resource units to derive an overall fatigue level.

9. The method of claim 8 wherein calculating a fatigue level includes:
tracking a homeostatic pressure and a circadian rhythm for the individual resource units for the assigned shifts; and
calculating the fatigue level as a difference between the homeostatic pressure and a value of the circadian rhythm.

10. The method of claim 8 wherein calculating a fatigue level includes:
tracking a homeostatic pressure for the individual resource units by increasing the homeostatic pressure in a saturating exponential manner asymptoting at 1 during wakefulness and decreasing the homeostatic pressure in a saturating exponential manner asymptoting at 0 during sleep;
evaluating a circadian rhythm for the individual resource units; and
calculating the fatigue level as a difference between the homeostatic pressure and a value of the circadian rhythm.

11. The method of claim 1 wherein the objective function further encapsulates at least one operational outcome, and wherein evaluating the objective function includes evaluating the objective function to select a roster from the plurality of generated rosters, the selected roster being simultaneously optimized for the operational outcome and the overall fatigue metric, and wherein the method further comprises:
adjusting a relationship between the operational outcome and the desired overall fatigue level; and
re-evaluating the objective function to select a roster from the plurality of generated rosters, the selected roster being simultaneously optimized for the operational outcome and the desired overall fatigue level in the adjusted relationship.

12. The method of claim 1 wherein evaluating the objective function includes selecting a roster from the plurality of generated rosters, the selected roster having an overall fatigue level lower than the other possible rosters.

13. The method of claim 1, wherein evaluating the objective function includes:
(i) comparing a first value of the objective function for a first roster to a second value of the objective function for a second roster, the second value and the second roster being stored in a buffer;
(ii) if the first value is lower than the second value, storing the first value and the first roster in the buffer;
(iii) else, maintaining the second value and the second roster in the buffer; and
wherein the method further includes repeating steps (i)-(iii) until at least some of the possible rosters have been processed.

14. A computer implemented method for generating a roster for an operation, the operation having at least one operational constraint and at least one operational outcome, wherein the method comprises:
generating a roster within the operational constraint by assigning a plurality of workers to a plurality of individual shifts;
calculating a value of the operational outcome based on the assigned shifts in the roster;
calculating an overall fatigue value for the assigned individual workers based on the assigned shifts in the roster; and
determining whether the generated roster is optimized based on the calculated value of the operational outcome and the overall fatigue value of the workers.

15. The method of claim 14, further comprising calculating a number of permutations of possible rosters based on a number of the workers and a number of the shifts, wherein determining whether the generated roster is optimized includes determining whether a combination of the value of the operational outcome and the overall fatigue value of the roster is smaller than the other possible rosters.

16. The method of claim 14, further comprising calculating a number of permutations of possible rosters based on a number of the workers and a number of the shifts, wherein determining whether the generated roster is optimized includes determining whether a combination of the value of the operational outcome and the overall fatigue value of the roster is larger than the other possible rosters.

17. The method of claim 14 wherein calculating an overall fatigue value includes:
tracking a homeostatic pressure and a circadian rhythm for the individual workers during the assigned shifts;
calculating a fatigue value for the individual workers as a difference between the homeostatic pressure and a value of the circadian rhythm based on the corresponding shifts; and
summing the fatigue values of the individual workers to derive the overall fatigue value for the roster.

18. The method of claim 14, further comprising:
calculating a number of permutations of possible rosters based on a number of the workers and a number of the shifts;
calculating an overall score for the roster as a weighted mean of the value of the operational outcome and the overall fatigue value; and
wherein determining whether the generated roster is optimized includes determining whether the overall score of the roster is smaller than the other possible rosters.

19. The method of claim 14, further comprising:
calculating a number of permutations of possible rosters based on a number of the workers and a number of the shifts;
calculating an overall score for the roster as a weighted mean of the value of the operational outcome and the overall fatigue value; and
wherein determining whether the generated roster is optimized includes determining whether the overall score of the roster is greater than the other possible rosters.

20. The method of claim 14 wherein calculating an overall fatigue value includes:
tracking a homeostatic pressure and a circadian rhythm for the individual workers during time periods corresponding to the assigned plurality of shifts;
calculating a fatigue value for the individual workers as a difference between the homeostatic pressure and a value of the circadian rhythm based on the corresponding one of the shifts assigned to the individual workers;
summing the fatigue values of the individual workers to derive an overall fatigue value; and
adding a bias fatigue value to the overall fatigue value if one of the workers is assigned to more than one shift during a time period.

21. A system for generating a roster for assigning a plurality of shifts to a plurality of workers in an operation, the operation having at least one operational constraint and at least one operational outcome, comprising:
a rostering module that generates a plurality of possible rosters based on the shifts, the workers, and the at least one operational constraint;
a fatigue module operatively coupled to the rostering module, wherein the fatigue module evaluates fatigue of the workers based on the assigned shifts in the plurality of rosters; and
wherein the rostering module selects a roster from the plurality of possible rosters, the selected roster being simultaneously optimized for both the operational outcome and the fatigue of the workers.

22. The system of claim 21 wherein the fatigue module
tracks a homeostatic pressure and a circadian rhythm for the individual workers during time periods corresponding to the assigned plurality of shifts;
calculates a fatigue value for the individual workers as a difference between the homeostatic pressure and a value of the circadian rhythm based on the corresponding one of the shifts assigned to the individual workers; and
sums the fatigue values of the individual workers to derive an overall fatigue value.

23. The system of claim 21 wherein the fatigue module
tracks a homeostatic pressure and a circadian rhythm for the individual workers during time periods corresponding to the assigned plurality of shifts;
calculates a fatigue value for the individual workers as a difference between the homeostatic pressure and a value of the circadian rhythm based on the corresponding one of the shifts assigned to the individual workers;
sums the fatigue values of the individual workers to derive an overall fatigue value; and
wherein the roster module calculates a combination of a value of the operational outcome and the overall fatigue value of the individual rosters and adds a bias to the combination of the value of the operational outcome and the overall fatigue value of the individual rosters if the corresponding roster violates the operational constraint.

24. The system of claim 21 wherein the rostering module
compares a first overall fatigue value of a first roster to a second overall fatigue value of a second roster, the second overall fatigue value and the second roster being stored in a buffer; and
if the first overall fatigue value of the first roster is lower than the second overall fatigue value, stores the first overall fatigue value and the first roster in the buffer;
else, maintains the second overall fatigue value and the second roster in the buffer; and
wherein the method further includes repeating evaluating the objective function until at least some of the rosters have been processed.
